(19) United States
(12) Patent Application Publication
(10) Pub. No.: US 2004/0041818 A1
(43) Pub. Date: Mar. 4, 2004

(54) Design system for website text graphics

(75) Inventors: Jeffrey Raymond White, Middlesex (GB); Jonathan David Roberts, Camberley (GB)

Correspondence Address: Don W. Bulson, Esq., Renner, Otto, Boisselle & Sklar, P.L.L., 19th Floor, 1621 Euclid Ave., Cleveland, OH, 44115, US

(73) Assignee: Jvolution Limited

(21) Appl. No.: 10/230,713

(22) Filed: Aug. 29, 2002

(51) Int. Cl. G09G 5/00

(52) U.S. Cl. 345/619

(57) ABSTRACT

A web design system for generating webpages containing text graphics in which the text graphics are generated dynamically using a text graphics generator to apply preconfigured style templates to text strings, wherein the style templates define a set of appearance attributes relevant to converting text strings into text graphics. The use of the text graphics generator is thus moved from a semi-manual process carried out by the web designer at the webpage design stage, to an automated process that is decoupled from the webpage design and deferred until the publishing stage. The system can be used either as a design tool by the web designer before delivering a static website, or for dynamic websites such as catalogue based sales websites with realtime stock control updates and frequent product line changes.

### BACKGROUND OF THE INVENTION

The invention relates to designing websites that include text graphics.

Webpages often use graphics for displaying text strings. These are known as text graphics and are used to avoid the limitations associated with fonts generated by a web browser. The appearance of text graphics are generally superior to the appearance of a text string displayed using fonts generated by a web browser because anti-aliasing and other special effects (e.g. shading patterns, color gradients, animation details etc.) can be used. In addition, a webpage will often employ customized fonts to help in creating a “brand-image”. These customized fonts will not generally be available to web browsers and text graphics must be used for displaying them.

The use of text graphics in a webpage involves generating and storing the text graphics as individual text graphics files in a memory of a host computer. Source code responsible for presenting the webpage will include references to the stored locations of the text graphics files. They can then be included on the webpage as desired. The webpage may be presented to a designer during an interactive design phase, or the webpage may be presented as a released (also known as ‘published’) webpage which is made available to a wider audience. The presenting of a published webpage is known as serving, and the host computer is said to serve the webpage to a client computer. During a design phase of a webpage, the host and client computers will generally be the same computer.

FIG. 1 schematically shows a system for incorporating text graphics into a webpage according to the prior art. A host computer 2 contains a processor 4 for interpreting hyper-text mark up language (HTML) source code and generating a webpage defined by the HTML source code. The HTML source code is stored in a source code memory 12. The webpage is served to a client computer 6 via an internet link 10. The client computer includes a display 8 for displaying the webpage to a user. In this example, the webpage comprises six text graphics 14a, 14b positioned as indicated on the display 8 shown in the figure. The six text graphics 14a, 14b correspond to three text strings, namely “AAA”, “MMM” and “YYY”, with each text string being shown twice, once non-italicized (identified by the reference numeral 14a) and once italicized (identified by the reference numeral 14b).

Each of the six text graphics are defined separately in six corresponding text graphics files 16. These are stored in text graphics file memory 18. The HTML source code instructs the processor to generate the webpage by defining the desired positions of the text graphics on the screen and providing the processor with the storage locations of the text graphics files 16 within the text graphics file memory 18. The processor 4 then generates and serves the webpage to the client computer 6.

Text graphics files, such as those shown in FIG. 1, are normally generated in isolation to the rest of the webpage since different software packages are required to create them. A separate text graphics file must be created for each different text string that is to be displayed in the webpage. Furthermore, multiple text graphics files will need to be created for even the same text string if it is to be displayed with a different characteristic appearance (e.g. size) at different locations within the webpage.

Both the creation and subsequent management of large numbers of text graphics files can present significant operational overheads for large webpages or websites which include large numbers of webpages. The need to generate and store individual text graphics files is especially burdensome during a design phase of a webpage. Not only must text graphics files be generated for each prototype version of the webpage, but references in the HTML source code itself must also be modified to reflect the different stored locations of the text graphics files used in each of the different prototype versions. This makes it difficult to rapidly change between and compare different prototype versions, unless multiple parallel copies of the HTML source code are maintained. To avoid version control problems, this is undesirable.

The separate storage of large numbers of text graphics files can also lead to difficulties in maintaining consistency of style, identifying correct storage location details and ensuring correct spelling of the text strings comprising the text graphics throughout a webpage. Accurate records of parameters associated with the appearance attributes of the text string must also be held to allow new text graphics files to be created in the same style. The fundamental reason for this overhead is that the “metadata” relating to each text graphics (i.e. the text string and its appearance characteristics) are not defined within the webpage, but are defined separately in the text graphics file.

A modification of even a single text graphics in a webpage, for instance to correct a spelling defect, can be time consuming. The location of the text graphics file associated with the text graphics to be modified must first be determined, for example by reference to the webpage HTML source code. The replacement text graphics must then be created, with reference to appropriate records of parameters associated with the characteristic appearance of the text string (which may require input from the original designer). The replacement text graphics must then be copied to the appropriate location within the text graphics file storage system. Making a global change to all of the text graphics within a webpage (for instance, because of a change in a corporate color) requires repeating this process many times.

When making changes to text graphics, it is not uncommon for inconsistencies to be introduced. For example, differences in font ascender heights and leader distances, or even in font size itself, can occur. These differences cause variations in supposedly similar text graphics when moving through the webpage, or when images are superimposed on dynamic pull-down menu buttons. Inconsistencies such as these can severely detract from a user's appreciation of a webpage.

Furthermore, there are circumstances where conventional stored text graphics files cannot be employed. In many cases the details of a text string to be displayed are not known in advance. One example is where a webpage needs to present information retrieved from a large database for which each entry cannot be realistically stored as text graphics file. Another example is where user-supplied text strings, such as a user's name, are to be displayed. In these cases, and others where no text graphics file exists, the text string must be displayed in a standard browser generated font.

### SUMMARY OF THE INVENTION

According to a first aspect of the invention there is provided a method of generating a website comprising a plurality of linked webpages containing text graphics, comprising: providing a plurality of text strings containing content for the website; providing a plurality of style template files each defining a set of appearance attributes relevant to converting text strings into text graphics; and generating the webpages dynamically by using a text graphics generator to apply one of the style template files to each of the text strings, thereby providing the text graphics with the appearance attributes defined by the style template files.

The use of the text graphics generator is thus moved from a semi-manual process carried out by the web designer at the webpage design stage, to an automated process that is decoupled from the webpage design and deferred until the publishing stage. This allows text graphics to be handled with similar flexibility to that provided by a “style-sheet” approach sometimes used with browser generated fonts.

This method can be used either as a design tool by the web designer before delivering a static website, or for dynamic websites such as catalogue-based sales websites with realtime stock control updates and frequent product line changes. When used as a web design tool, the web designer will repeatedly “republish” the webpages by using the text graphics generator to automatically apply the desired style template files to the text strings. This contrasts from the conventional approach where the web designer wishing to modify the appearance of text graphics on a webpage would individually recreate each item of text graphics he or she wished to change by using applications software to generate a modified text graphics file.

By generating the text graphics in the webpages at the publishing stage in an automated fashion, frequent changes can be made to either the text string or its appearance attributes. The method also allows the appearance attributes of any number of text graphics items to be changed consistently, simply by modifying an associated style template. There is no need to regenerate an entire series of new text graphics in a semi-manual fashion, as would be done conventionally. The method allows a web designer to work more efficiently during a design phase of the webpage, and also reduces the administrative overheads and likely sources of errors and inconsistencies which are associated with maintaining a library of individual text graphics files.

The method also allows text graphics to be generated on the fly from user input and included in the webpage, even though the text string displayed as text graphics will not be known in advance. A website may thus be predominantly static, but use the method of the invention to match user inputted text to the style of the surrounding (static) webpage. This is done by making an appropriate style template available. If the website has been designed using the method of the invention, the same style template can be made available to handle user inputted text strings as was used earlier by the website designer to generate the static text graphics content of the website.

The style templates files may be conveniently generated by a style template generating tool having a graphical user interface comprising dialogue fields for specifying the appearance attributes.

This allows different style templates to be created rapidly and intuitively. The style template generating tool can also help to maintain consistency between families of similar style templates, for instance by ensuring that each style template in a family is generated with consistent characteristic appearance parameters (such as font, or color for example) which are common to the family.

The step of generating the webpages may advantageously include storing the text graphics as text graphics files in a memory together with identifying tags, the identifying tags being determined by the text graphics generator from the style template filenames and the text strings used to generate the text graphics. The text graphics generator can then be designed so that it applies a style template file to a text string initially to determine an identifying tag. The memory is then searched for a previously generated and stored text graphics file with a matching identifying tag. The text graphics can then be provided by retrieval of the existing text graphics file, if a text graphics file with a matching identifying tag is located. Otherwise, the text graphics can be provided by generating a text graphics file in which case the text graphics file can also be stored with its identifying tag so that it is available for future use.

By storing the text graphics in files marked with identifying tags, text graphics which are frequently required can be provided without the computing overhead of regeneration. This can be particularly useful in a design phase where the webpage will need frequent redisplaying while only a small number of text graphics may have been modified since a previous displaying.

The text strings may either be stored text strings, or text strings provided interactively by a user as input to the website. In many cases, the text strings will be a combination of both.

According to a second aspect of the invention there is provided a computer program product carrying machine readable instructions for implementing the method of the first aspect of the invention. The machine readable instructions may be stored in a recording medium, such as volatile or non-volatile computer memory, magnetic or optical storage media. The machine readable instructions may also be conveyed on a transmission medium, such as a wireless transmission medium, a conducting cable or an optical cable.

According to a third aspect of the invention there is provided a computer system comprising: a memory in which is stored a plurality of style template files each defining a set of appearance attributes relevant to converting text strings into text graphics; and a text graphics generator operable to generate webpages dynamically by applying appropriate ones of the style template files to the text strings, thereby providing the text graphics with the appearance attributes defined by the style template files.

### BRIEF DESCRIPTION OF THE DRAWINGS

For a better understanding of the invention and to show how the same may be carried into effect reference is now made by way of example to the accompanying drawings in which:

FIG. 1 schematically shows a known system for serving a webpage which includes text graphics;

FIG. 2 schematically shows a system for serving a webpage including text graphics according to a first embodiment of the invention;

FIG. 3a schematically shows a style template file for defining the characteristic appearance of text graphics to be included into a webpage using the system of FIG. 2;

FIG. 3b schematically shows another style template file for defining the characteristic appearance of text graphics to be included into a webpage using the system shown in FIG. 2;

FIG. 4a schematically shows the appearance of text graphics generated using the system shown in FIG. 2 with reference to the style template file shown in FIG. 3a;

FIG. 4b schematically shows the appearance of text graphics generated using the system shown in FIG. 2 with reference to the style template file shown in FIG. 3b;

FIG. 5 is a computer screen shot showing a user interface of a style template generating tool for generating style template files similar to those shown in FIGS. 3a and 3b;

FIG. 6 schematically shows a style template file generated by a style template generating tool for defining the characteristic appearance of text graphics to be included into a webpage using the system of FIG. 2;

FIG. 7 schematically shows the appearance of a webpage including two text graphics generated using the system shown in FIG. 2 with reference to the style template file shown in FIG. 6;

FIG. 8 shows a section of hypertext mark-up language (HTML) for generating the webpage shown in FIG. 7.

FIG. 9 schematically shows a system for serving a webpage including text graphics according to a second embodiment of the invention; and

FIG. 10 is a flow chart schematically showing a method for designing a webpage including text graphics which are generated dynamically.

### DETAILED DESCRIPTION

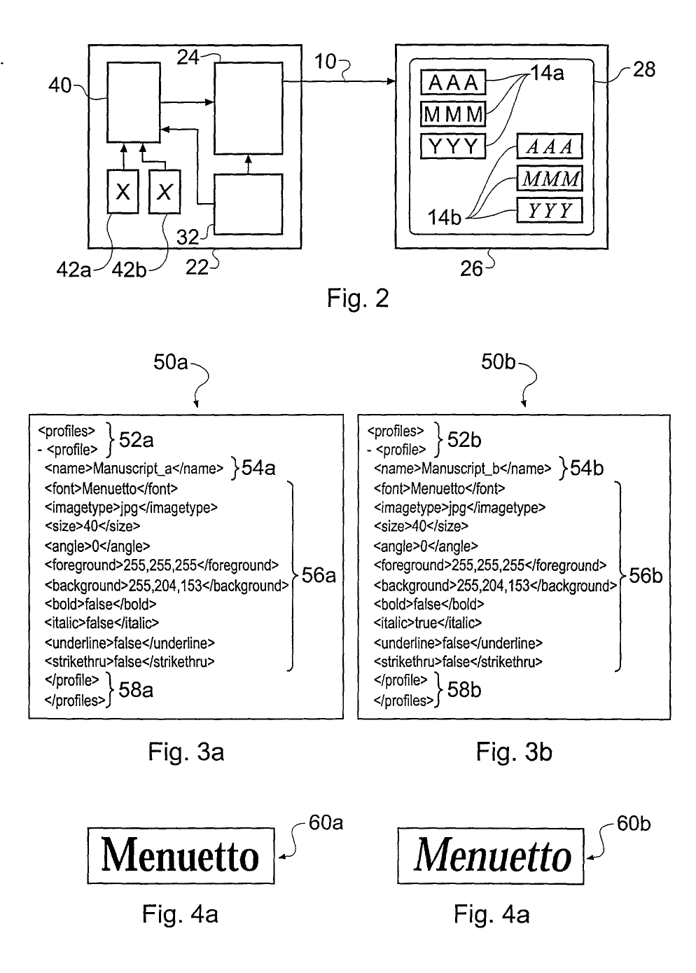

FIG. 2 schematically shows a system for serving a webpage from a host computer 22 to a client computer 26 according to a first embodiment of the invention. The webpage includes text graphics which are generated dynamically by the host computer 22. The host computer 22 includes a processor 24, a source code memory 32, text graphics generator 40 and, in this example, two style templates 42a, 42b. The client computer 26 includes a display 28 for displaying the webpage which is served to it by the host computer via an internet link 10. During design and development of the webpage, the functions of the host and client computers will generally be provided by a single computer. In such cases, local connections within the computer will correspond to the internet link 10.

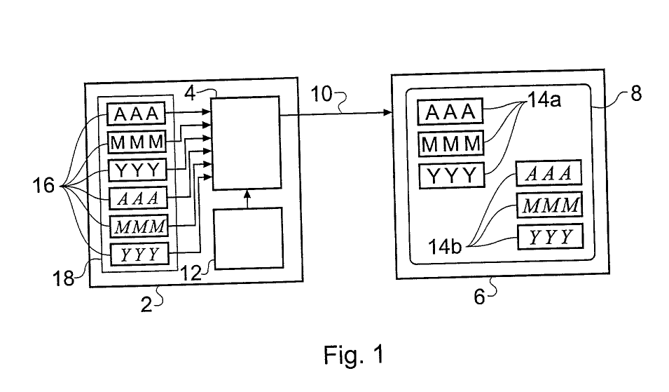

The processor 24 is operable to interpret hyper-text mark up language (HTML) source code and generate and serve a corresponding webpage. The HTML source code defining the webpage is stored in the source code memory 32. In this example, the webpage defined by the HTML source code is similar to that shown in FIG. 1. The webpage again comprises six text graphics 14a, 14b, positioned as indicated in the figure.

However, unlike the system shown in FIG. 1, the text graphics 14a, 14b seen displayed in FIG. 2 are generated dynamically by the text graphics generator, and are not retrieved from text graphics files. Although shown separately in FIG. 2, the functionality of the text graphics generator 40 will generally be provided by a process running on the processor 24. The text graphics generator 40 is operable to generate a text graphics image for inclusion in the webpage under instruction from the HTML source code and with reference to one of the style templates 42a, 42b.

The text graphics generator reads the parameters defined in the style template and uses them to generate a graphic representation (i.e. a text graphics) of the text string using graphics instructions in a standard computer graphics library. The system shown in FIG. 2 uses the Java 2D application program interface (API) but the system could use other computer graphics libraries such as the Microsoft graphics device interface (GDI) library.

Each style template corresponds to a set of parameters stored in a style template file. Throughout the following description, it will be assumed that each style template is stored in a separate style template file. However, it will be appreciated that in other cases, multiple style templates may be stored in a single style template file, for instance to assist in management of the different style templates. For example, all of the style templates relating to a set of linked webpages could be stored in a single style template file, with separate sections of the single style template file relating to different style templates. Each section would be marked by an identifying entry to indicate which style template is defined in each section of the single style template file.

Each of the parameters stored in a style template file specify an appearance attribute relevant for text graphics. There are a large number of possible appearance parameters which can be specified by a style template. These may include, for example, foreground color, background color, details of font style (i.e. basic text geometry (or specific font), whether italic and/or bold and/or underlined etc.), font size, text position relative to a bounding box of the text graphic, details of any desired animation effects and so on. The style templates 42a, 42b may be stored in style template files in any known format. The system shown in FIG. 2 uses extensible markup language (XML) tags to store style properties although comma separated value (CSV) or fixed format files could also be used.

In the system shown in FIG. 2, there are two style templates 42a, 42b. A first style template 42a contains parameters for defining the appearance of the text graphics identified by the reference numeral 14a shown in FIG. 2, and a second style template 42b contains parameters for defining the appearance of the text graphics identified by the reference numeral 14b. In this example, the characteristic appearance of each of the text graphics 14a, 14b is generally similar. Both define black lettering in a basic font against a white background. However, the second style template 42b further specifies that the text string within the text graphics should be italicized. The second style template 42b could be used to define the appearance attributes of a text string which is to be used as an italicized heading within a webpage. The first style template 42a might then be used to define the appearance attributes of text which occurs within the main body of the webpage. The first and second style templates 42a, 42b are respectively marked ‘X’ and ‘X’ in FIG. 2 to schematically indicate the appearance attributes of a text string generated with reference to each of them.

While only two style templates are shown in FIG. 2, in general there will be several style templates for defining the appearance attributes of different classes of text string to be displayed within a webpage. Such classes might be banners, page headings, sub-headings, option, headers, menu buttons and so on. By defining a different style template for each class, text graphics falling in the same class can be displayed consistently throughout the webpage.

The text strings to be included in text graphics generated by the text graphics generator 40 are specified by the HTML source code along with the style template to be used. It is noted that the text string may not explicitly appear in the HTML source code, but may instead be specified by virtue of the fact that the HTML source code instructs a user to supply a text string (e.g. their name), or extracts a string from another source (e.g. a database). The text graphics generated by the text graphics generator are passed to the processor 24 for inclusion in the webpage to be served. The dynamically generated text graphics can be created according to any suitable image format. For example, static or animated graphics interchange format (GIF), joint photographic experts group (JPEG) format, portable network graphics (PNG) format, bitmap (BMP) format or tagged image file format (TIFF). By conforming to a recognized format, the text graphics can be dynamically generated without impacting the operation of the processor, i.e. the fact that the text graphics are generated dynamically can be made transparent to the processor.

By employing the system shown in FIG. 2, a change to the text string represented in one of the text graphics can be achieved by simply modifying a section of the HTML source code specifying the text string. When the modified webpage is served, the text graphics generator dynamically generates a text graphics which reflects the new text string, and this is include in the webpage. There is no need with the system shown in FIG. 2 for a new text graphics file to be separately generated and stored. Similarly, a change to the characteristic appearance of a text graphics can be achieved by modifying a section of the HTML source code specifying the style template to be employed when generating the text graphics. There is again no need for a new text graphics file to be generated and stored.

FIG. 3a shows the details of a first example style template file 50a for defining a style template for use in the system shown in FIG. 2. For simplicity, the style template file 50a shown in FIG. 3a contains relatively few entries. In general, a style template file will contain numerous other entries for defining the characteristic appearance of other aspects of text graphics. The style template file 50a includes a preamble entry section 52a, a style template filename entry 54a, an appearance attribute entry section 56a and a terminating entry section 58a. The preamble entry section 52a and the terminating entry section 58a are used as markers to indicate the beginning and end of the style template file 50a to the text graphics generator. Similar markers may be used in a single style template file defining multiple style templates to separate the sections relating to different style templates. The style template filename entry 54a is unique to the style template file 50a and is used to identify it. An entry similar to the style template filename entry 54a would be used as an identifying entry in cases where multiple style templates are stored in a single style template file, as discussed above. In this example the style template filename is “Manuscript_a”. This is the name used by the HTML source code to indicate to the text graphics generator that that particular style template file (or a corresponding section of a single style template file which defines multiple style templates) should be used for defining the characteristic appearance of text graphics to be generated. The appearance attribute entry section 56a contains individual entries relating to the different parameters used by the text graphics generator in generating text graphics.

It can be seen from FIG. 3a that the entries in the appearance attribute entry section 56a specify that text graphics generated with reference to the style template 50a will be in Menuetto font, will be in JPEG format (identified by the entry “<imagetype>jpg</imagetype>”), will have a character size of 40 in point size units, will not be angled to the horizontal, will have a foreground color specified by the RGB vector 255, 255, 255, will have a background color specified by the RGB vector 255, 204, 153, will not be bold, will not be italic, will not be underlined and will not have a line drawn through the text (known as strikethru).

FIG. 4a schematically shows an example text graphics 60a generated with a characteristic appearance described by the parameters entered into the appearance attribute entry section 56a of the style template file 50a shown in FIG. 3a. The text graphics contains the text string “Menuetto”.

FIG. 3b shows the details of a second example style template file 50b. The second style template file 50b is similar to the first style template file 50a, and again includes a preamble entry section 52b, a style template filename entry 54b, a appearance attribute entry section 56b and a terminating entry section 58b. These features are similar to and will be understood from the corresponding features described above with reference to FIG. 3a. In this example the style template filename is “Manuscript_b”.

It can be seen from FIG. 3b that the entries in the appearance attribute entry section 56b specify that text graphics generated with reference to the “Manuscript_b” style template will appear similar to text graphics generated with reference to the “Manuscript_a” style template, but will be italicized. This is apparent from a comparison of the entries in the appearance attribute entry sections 56a, 56b shown in FIGS. 3a and 3b. The two appearance attribute entry sections 56a, 56b are similar, except the first example style template file 56a includes an entry “<italic>false</italic>” while the second example style template file 56b includes an entry “<italic>true</italic>”. These entries are interpreted by the text graphics generator to indicate that text graphics should be generated with a non-italicized and italicized appearance respectively.

FIG. 4b schematically shows an example text graphics 60b with a characteristic appearance described by the entries in the appearance attribute entry section 56b of the style template file 50b shown in FIG. 3b. The text graphics again contains the text string “Menuetto”.

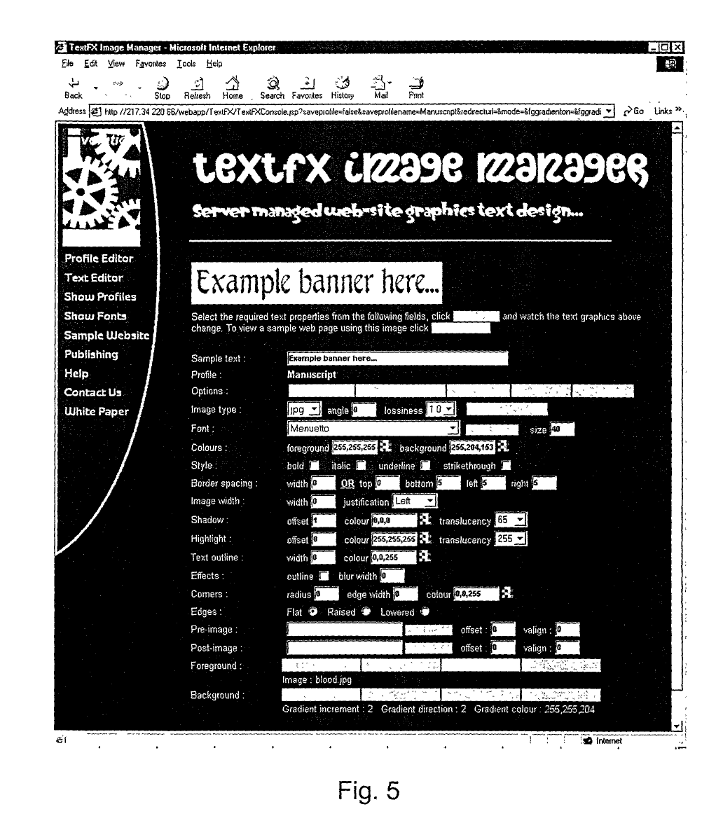

FIG. 5 is a computer screen shot of a graphical user interface for a computer implemented style template generating tool for generating a style template file describing a style template. The style template generating tool accepts input from a user via dialogue fields in the graphical user interface in order to set appearance attributes to be written to the style template file by a file storage component of the style template generating tool. Once the parameters have been set according to a user's requirements, the style template generating tool can generate and store an appropriate style template file, for example of the form shown in FIGS. 3a and 3b. Several parameters for defining the characteristic appearance of text graphics can be set. For example, it can be seen from the user interface shown in FIG. 5, that the style template generating tool is configured to generate a style template file with a filename (or ‘profile’ name) of “Manuscript”, and in which the font is Menuetto, the font size is 40, the image type is JPEG, and so on. These (and the other parameters shown in FIG. 5) can be set by direct user input. Some parameters can also be set via a pull-down menu system which details the options available, for example a pull-down menu might list all of the available fonts.

Before generating and storing a corresponding style template file, the characteristic appearance of text graphics generated with reference to the parameters entered into the user interface can be seen in an example text display window within the user interface. In the example shown in FIG. 5, the example text display window contains the text “Example banner here . . . ”. It is noted that style template files can be created in several other ways, for example, they could be created from ‘scratch’ by manual editing of a computer text file. However, using a style template generating tool such as shown in FIG. 5 can help to rapidly generate different style template files for describing different style templates. Such a tool can also help to maintain consistency within a family of similar style template files. For instance, a designer of a webpage may require several style templates for generating text graphics of similar overall appearance, but with differently sized text being represented. In such a case, each of the family of similar style templates can be created by the style template generating tool with modification only to a setting of the desired text size.

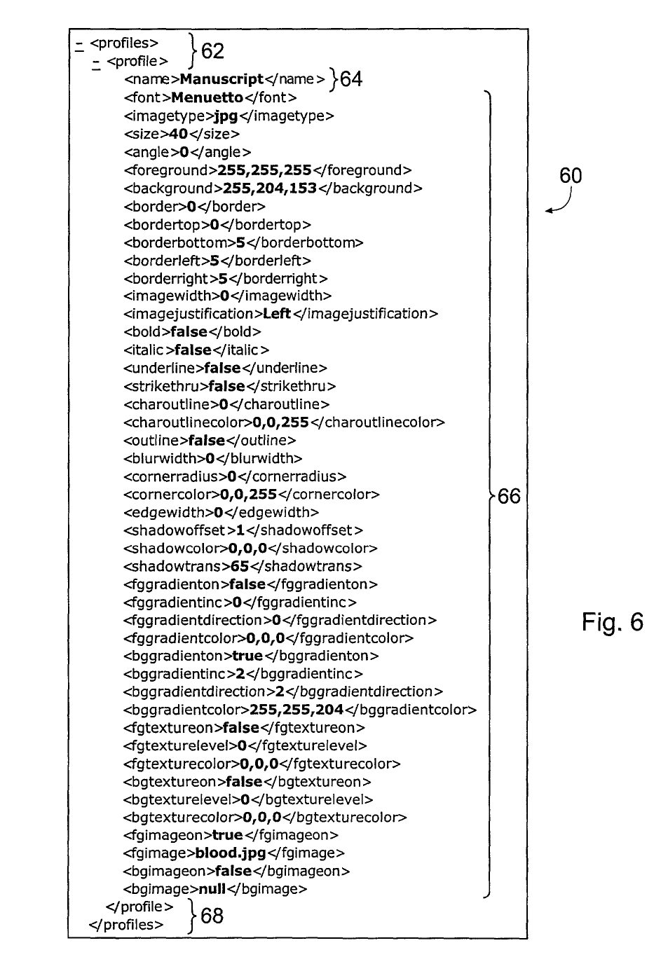

FIG. 6 shows an example style template file 60 generated by a style template generating tool using the settings shown in the user interface shown in FIG. 5. The style template file 60 includes a preamble entry section 62, a style template filename entry 64, an appearance attribute entry section 66 and a terminating entry section 68. These features are similar to and will be understood from the corresponding features shown in FIGS. 3a and 3b. In the style template file shown in FIG. 6 it can be seen that the name of the style template described in the style template file is “Manuscript”. The style template file 60 shown in FIG. 6 provides a more comprehensive list of parameters or attributes for defining the characteristic appearance of text graphics than the style template files 50a, 50b shown in FIGS. 3a and 3b. In other cases, more or fewer entry fields corresponding to more or fewer characteristic appearance parameters may be included in a user interface, such as the one shown in FIG. 5.

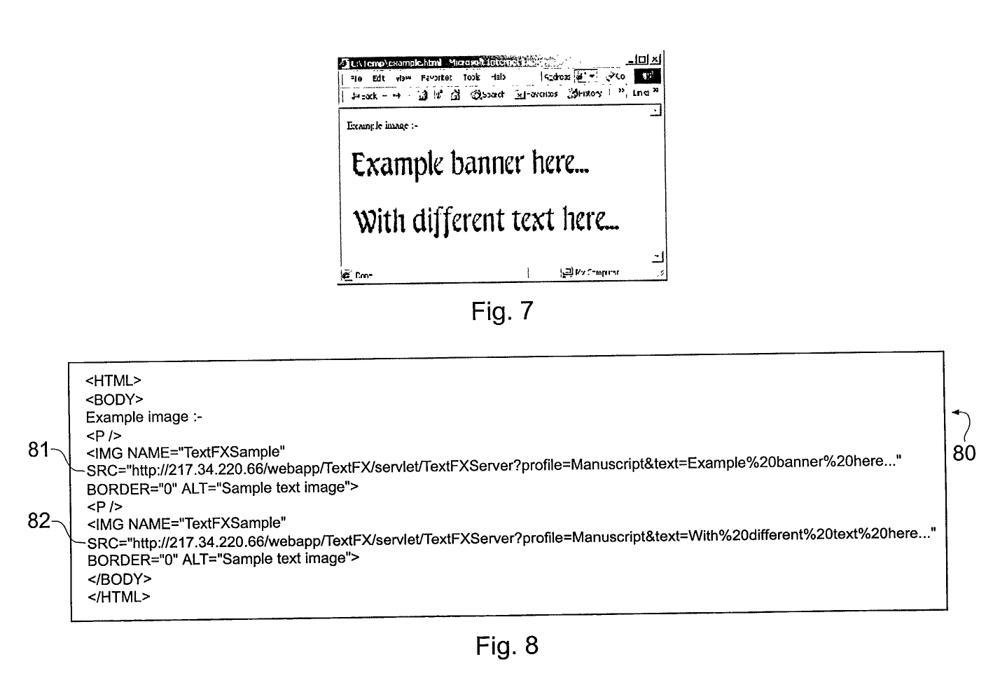

FIG. 7 shows a screen shot of a computer screen display displaying a webpage. The webpage includes a browser generated text string containing the text “Example image:-” in the upper left hand corner of the display. The webpage also includes two text graphics generated by a text graphics generator. A first text graphics containing the text “Example banner here . . . ” is positioned approximately centrally on the display, and a second text graphics containing the text “With different text here . . . ” is positioned beneath the first text graphics. The first and second text graphics shown in FIG. 7 are both generated using the style template described in the style template file 60 shown in FIG. 6.

FIG. 8 shows a section of HTML source code 80 which defines the appearance of the webpage shown in FIG. 7. The HTML source code shown in FIG. 8 conforms to normal HTML source code standards. A first SRC entry 81 and a second SRC entry 82 in the HTML source code correspond to instructions for generating the first and second text graphics shown in FIG. 7 respectively. SRC is a standard HTML term used to indicate the source of an image file. With prior art systems (where text graphics are retrieved from individual text graphics files stored in a memory) the SRC entries 81, 82 would be replaced with SRC entries which detail the location of the relevant stored text graphics files. The use of the text graphics generator to dynamically generate the text graphics can be easily implemented in existing HTML source code simply by changing the relevant SRC entries to the form shown in FIG. 8. There is no need to modify the bulk of an existing webpage to allow it to use dynamically generated text graphics. In this example, the functionality of the text graphics generator is provided by a Java programming language based application. The SRC entries 81, 82 are accordingly directed towards the Java application, and pass to it the relevant operands, namely the text string and the style template to be used in generating the text graphic. It can be seen from the first sections of the SRC entries 81, 82 shown in FIG. 8 that the Java application operates from an address “http://217.34.220.66/webapp/TextFX/servlet/TextFXserver”. It can also be seen from the second sections that the operands “profile” and “text” are required by the Java application. The “profile” operand specifies the style template to use and the “text” operand specifies the text string to be displayed in the text graphics. The style template used for both of the text graphics shown in FIG. 7 is the “manuscript” style template described in the style template file shown in FIG. 6. The “text” operands for the first and second entries are “Example banner here . . . ” and “With different text here . . . ” respectively. Accordingly, the SRC entries 81, 82 instruct the text graphics generator to generate the text graphics shown in FIG. 7.

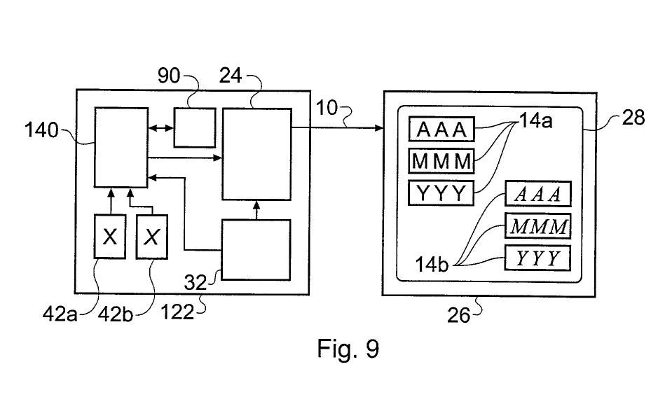

FIG. 9 schematically shows a system for serving a webpage from a host computer 122 to a client computer 28 according to a second embodiment of the invention. Many of the features shown in FIG. 9 are similar to and will be understood from the description of the corresponding features shown in FIG. 2. However, the host computer 122 includes a cache memory 90 and a modified text graphics generator 140. The text graphics generator 140 is coupled to the cache memory 90, but is otherwise similar to the text graphics generator 40 shown in FIG. 2. The cache memory is operable to receive and store text graphics files containing text graphics images which have been dynamically generated and transmitted to it by the text graphics generator. Each text graphics file stored in the cache memory is attributed an identifying tag by the text graphics generator, for example as an associated filename. The identifying tag identifies the style template and text string used in generating the text graphics file. The time of creation may also be encoded into the identifying tag. The identifying tag may be generated, for example, by applying a hashing algorithm to a concatenation of the text string, the filename associated with the style template and the time of creation of the style template. When the text graphics generator is required to generate text graphics of a requested text string and characteristic appearance, it first searches the cache memory for a stored text graphics file with a correspondingly appropriate identifying tag. If a stored text graphics file with an appropriate tag is found, this indicates that a text graphics file containing the requested text string with the requested characteristic appearance has already been generated and stored. If no appropriate tag is found, the text graphics generator proceeds to generate the text graphic. If a text graphics file containing an appropriate text graphics is stored in the memory and the style template has not been modified since its creation, the text graphics generator retrieves the requested text graphics from the appropriate text graphics file, and does not generate it again. This avoids the computational overhead of repeatedly generating the same text graphics but maintains the flexibility of using a text graphics generator to dynamically generate text graphics. This makes it possible to make frequent changes to the characteristic appearance of a particular text graphics, or family of text graphics, without unmodified text graphics being regenerated every time the webpage is redisplayed. If a style template has been modified since last being applied to a particular text string, and the associated style template file has not been given a different name, the time of creation encoded into the identifying tag is compared to the time of modification of the style template to ensure text graphics file in the cache memory is regenerated to reflect the change in style template.

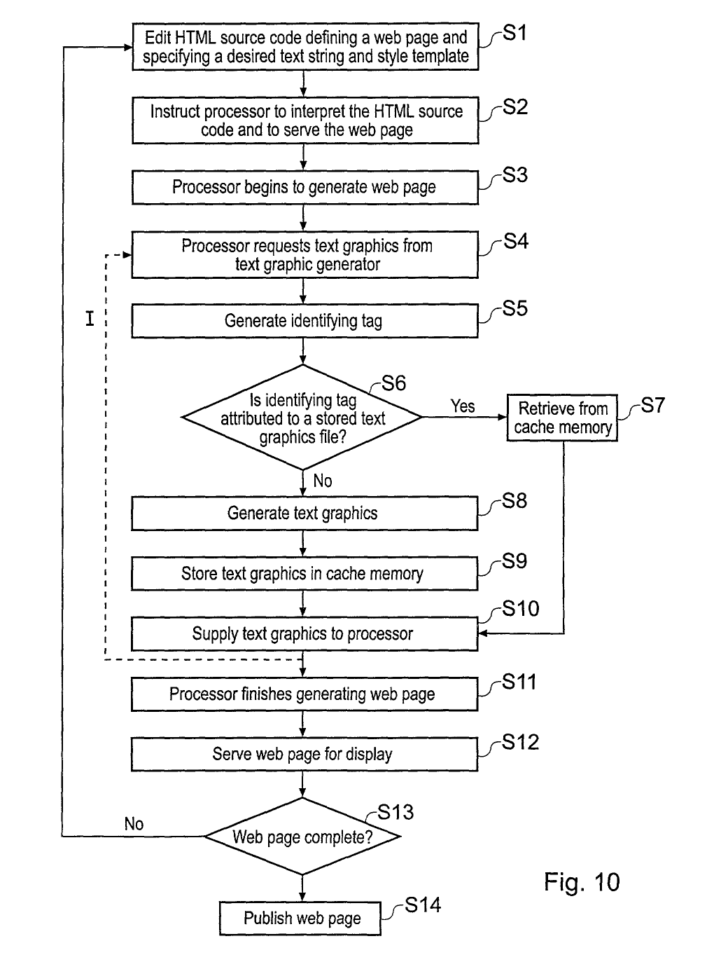

FIG. 10 is a flow chart schematically showing a method for designing a webpage including text graphics which are generated dynamically with a system similar to those described above. In step S1, a designer edits HTML source code which defines a webpage. Step S1 will generally correspond to editing an existing section of HTML source code, although the HTML source code may also be created from scratch. The HTML source code specifies text strings to be displayed and corresponding style templates for each of the text graphics. This may be done, for example, by commands similar to the SRC entries 81, 82 shown in FIG. 8. In step S2, a processor is instructed to interpret the HTML source code and serve the corresponding webpage. In step S3, the processor begins its interpretation of the HTML source code in the normal manner. In step S4, having interpreted a command similar to the SRC entries 81, 82 seen in FIG. 8, the processor requests an item of text graphics from a text graphics generator. In step S5, the text graphics generator generates an identifying tag based on the text string and style template. In step S6, the text graphics generator determines whether a text graphics file containing the requested text graphics in question already exists within a cache memory by a comparison between the current identifying tag and those attributed to text graphics files within the cache memory. If a text graphics file containing the requested text graphics exists in the cache memory, the ‘Y’ branch from step S6 to step S7 is taken. In step S7 the requested item of text graphics is retrieved from the appropriate text graphics file in the cache memory. If a suitable text graphics file containing the requested text graphics does not exist in the cache memory, the ‘N’ branch from step S6 to step S8 is taken. In step S8 the text graphics generator generates the requested text graphics as described above. In step S9 the generated text graphics are stored in the cache memory, along with a corresponding identifying tag. In step S10 (which will be executed after either step S7 or S9 depending on which branch was taken from step S6) the text graphics generator supplies the requested text graphics to the processor for inclusion in the webpage. The processor continues to interpret the HTML source code until arriving at step S11, at which point it has finished the interpretation of the HTML source code and the webpage is ready for display. It is noted that the webpage will generally include multiple text graphics. Each item of text graphics will be handled as above in steps S4 to S10. These steps are repeated for each item of text graphics, as indicated by an iteration return branch shown as a dotted line and marked ‘I’ in FIG. 10. In step S12, the finished webpage is served by the processor for display to the designer. In step S13, the designer determines whether the appearance of the webpage is acceptable. If the designer is not content, perhaps because he or she wishes to change a text string displayed in text graphics, or display a text string with a different characteristic appearance, the ‘N’ branch from S13 to S1 is taken. The designer may then edit the HTML source code to reflect changes to be made to the webpage and the steps outlined above are repeated until again reaching step S12. The designer again decides whether he or she is content with the appearance of the webpage, and if not can return to step S1 to apply further modifications. It will be understood that during this process the designer may be generating new style template files describing new style templates for use in generating the text graphics. When the designer is happy with the appearance of the webpage, the webpage design phase is complete. The HTML source code may remain unchanged such that the text graphics images continue to be dynamically generated each time the webpage is served to a client computer. (It is noted that if the cache memory is sufficiently large, it will generally contain all necessary text graphics such that they are always supplied to the processor via step S7 shown in FIG. 10. In such cases there will be no processor overhead associated with generating the text graphics.) However, in this example, on completion of the webpage design, the webpage is published in a publishing step S14.

The publishing step S14 involves generating each of the text graphics specified in the final version of the HTML source code (or at least those ones for which the text string to be displayed is known in advance) and writing them to corresponding text graphics files in a long term memory. The text graphics files are given filenames based on the identifying tag generated at step S5 shown in FIG. 10. The publishing step additionally involves modifying the HTML source code to replace commands directed to dynamically generating the text graphics (such as the SRC entries 81, 82 shown in FIG. 8) with commands directing the processor to the location of the relevant text graphics files stored in long term memory. Text graphics within the completed webpage which need to be dynamically generated (i.e. those containing text strings supplied by a user) will remain unaffected by the publishing step S14, and will continue to be dynamically generated each time the webpage is served.

When a webpage design is completed, the appropriate HTML source code, style template files and, for a published webpage, the text graphics files can be transferred to a remote computer. This allows a webpage to be designed by a designer and then transferred to the remote computer for hosting.

While the above description has been directed to alphabetic text strings, it will be appreciated that the term text string is considered to include other symbols, for instance, any of the symbols defined in the American Standard Code for Information Interchange (ASCII) character set. Furthermore, a text graphics generator such as those described above may be configured to generate images which are similar to text graphics, but which do not contain text. For instance, a company called “Cow Inc.” may have a company logotype comprising an image of a cow. The text graphics generator could then be configured to generate an image of a cow with a characteristic appearance (i.e. color, size, orientation, etc.) defined by a style template similar to those described above for generating text graphics.

1. A method of generating a website comprising a plurality of linked webpages containing text graphics, comprising:
providing a plurality of text strings containing content for the website;
providing a plurality of style template files each defining a set of appearance attributes relevant to converting text strings into text graphics; and
generating the webpages dynamically by using a text graphics generator to apply one of the style template files to each of the text strings, thereby providing the text graphics with the appearance attributes defined by the style template files.

2. The method of claim 1, wherein the style template files are generated by a style template generating tool having a graphical user interface comprising dialogue fields for specifying the appearance attributes.

3. The method of claim 1, wherein the step of generating the webpages includes storing the text graphics as text graphics files in a memory together with identifying tags, the identifying tags for the text graphics files being determined by the text graphics generator from the style template filenames and the text strings used to generate the text graphics.

4. The method of claim 3, wherein the text graphics generator applies a style template filename to a text string initially to determine an identifying tag, whereupon the memory is searched for a text graphics file with a matching identifying tag, wherein the text graphics are provided by retrieval of the existing text graphics file, if a text graphics file with a matching identifying tag is located, and if not, the text graphics are provided by generating a text graphics file which is also stored with its identifying tag.

5. The method of claim 1, wherein at least some of the text strings are stored.

6. The method of claim 1, wherein at least some of the text strings are provided interactively by a user as input.

7. A computer program product carrying machine readable instructions for implementing a method of generating a website comprising a plurality of linked webpages containing text graphics, comprising:
providing a plurality of text strings containing content for the website;
providing a plurality of style template files each defining a set of appearance attributes relevant to converting text strings into text graphics; and
generating the webpages dynamically by using a text graphics generator to apply one of the style template files to each of the text strings, thereby providing the text graphics with the appearance attributes defined by the style template files.

8. The computer program product of claim 7, wherein the style template files are generated by a style template generating tool having a graphical user interface comprising dialogue fields for specifying the appearance attributes.

9. The computer program product of claim 7, wherein the step of generating the webpages includes storing the text graphics as text graphics files in a memory together with identifying tags, the identifying tags for the text graphics files being determined by the text graphics generator from the style template filenames and the text strings used to generate the text graphics.

10. The computer program product of claim 9, wherein the text graphics generator applies a style template filename to a text string initially to determine an identifying tag, whereupon the memory is searched for a text graphics file with a matching identifying tag, wherein the text graphics are provided by retrieval of the existing text graphics file, if a text graphics file with a matching identifying tag is located, and if not, the text graphics are provided by generating a text graphics file which is also stored with its identifying tag.

11. The computer program product of claim 7, wherein at least some of the text strings are stored.

12. The computer program product of claim 7, wherein at least some of the text strings are provided interactively by a user as input.

13. The computer program product of claim 7, wherein the machine readable instructions are stored in a recording medium.

14. The computer program product of claim 7, wherein the machine readable instructions are conveyed on a transmission medium.

15. A computer system comprising:
a memory in which is stored a plurality of style template files each defining a set of appearance attributes relevant to converting text strings into text graphics; and
a text graphics generator operable to generate webpages dynamically by applying appropriate ones of the style template files to the text strings, thereby providing the text graphics with the appearance attributes defined by the style template files.

16. The computer system of claim 15, further comprising a style template generating tool with a graphical user interface comprising dialogue fields for specifying the appearance attributes, and a file storage component operable to store a style template file based on the appearance attributes specified in the dialogue fields.

17. The computer system of claim 15, wherein the text graphics generator is operable to store the text graphics as text graphics files in the memory together with identifying tags, the identifying tags for the text graphics files being determined by the text graphics generator from the style template filenames and the text strings used to generate the text graphics.

18. The computer system of claim 17, wherein the text graphics generator is operable to apply a style template filename to a text string initially to determine an identifying tag, whereupon the memory is searched for a text graphics file with a matching identifying tag, wherein the text graphics are provided by retrieval of the existing text graphics file, if a text graphics file with a matching identifying tag is located, and if not, the text graphics are provided by generating a text graphics file which is also stored with its identifying tag.
